(19) United States
(12) Patent Application Publication
(10) Pub. No.: US 2025/0033512 A1
(43) Pub. Date: Jan. 30, 2025

(54) Charging Management For Electric Work Vehicles

(71) Applicant: Caterpillar Inc., Peoria, IL (US)

(72) Inventors: Thomas L. TWIGGER, Spalding (GB); Steven GAHLINGS, Cambridge (GB)

(73) Assignee: Caterpillar Inc., Peoria, IL (US)

(21) Appl. No.: 18/715,963

(22) PCT Filed: Nov. 22, 2022
(86) PCT No.: PCT/US2022/080305

§ 371 Date: Jun. 3, 2024

(30) Foreign Application Priority Data
Dec. 3, 2021 (GB) 2117516.1

(51) Int. Cl. B60L 53/66; B60L 53/10; B60L 53/30; B60L 53/62

(52) U.S. Cl. CPC B60L 53/66; B60L 53/11; B60L 53/305; B60L 53/62; B60L 2200/40

(57) ABSTRACT

A method of charge management for electric work vehicles comprises communicating charger properties from a charging module to an electric work vehicle and communicating vehicle properties from the electric work vehicle to the charging module. Charging information is provided to an operator, wherein the charging information is based on the charger properties and the vehicle properties. The charger properties comprise a location of the charging module and an availability of the charging module. The vehicle properties comprise a current state of charge of a battery of the electric work vehicle and a capacity of the battery of the electric work vehicle.

### FIELD OF THE DISCLOSURE

The disclosure relates to the field of electric work vehicles.

### BACKGROUND

Large worksites typically have more than one charging point for electric work vehicles. The charging points may be at the same location or at different locations.

An operator of an electric work vehicle may not know the location of the charging points, particularly if the charging point locations vary between worksites or if the charging points are mobile. The operator may waste time and charge travelling to look for a charging point.

An operator of an electric work vehicles may travel to a charging point in order to charge without knowledge of any properties of the charging point, and so risk not being able to charge. For example, the charging point may be in use by another vehicle, low on power or charge, out of order, the wrong type of charging point, or otherwise unusable. In the event that an electric work vehicle cannot charge at the charging point, the electric work vehicle may be required to wait or to travel to a different charging point.

### SUMMARY OF THE DISCLOSURE

A method of charging management for electric work vehicles is provided, the method comprising communicating charger properties from a charging module to an electric work vehicle. The method further comprises communicating vehicle properties from the electric work vehicle to the charging module. The method further comprises providing charging information to an operator, wherein the charging information is based on the charger properties and the vehicle properties. The charger properties comprise location of the charging module and availability of the charging module. The vehicle properties comprise a current state of charge of a battery of the electric work vehicle and a capacity of the battery of the electric work vehicle.

A charging management device for electric work vehicles is provided. The charging management device is configured to communicate charger properties from a charging module to an electric work vehicle. The charging management device is further configured to communicate vehicle properties from the electric work vehicle to the charging module. The charging management device is further configured to provide charging information to an operator, wherein the charging information is based on the charger properties and the vehicle properties. The charger properties comprise location of the charging module and availability of the charging module. The vehicle properties comprise a current state of charge of a battery of the electric work vehicle and a capacity of the battery of the electric work vehicle.

Advantageously, the electric work vehicle is able to travel to a charging module that is known to be available and in working order. A charging decision may be made based on charging information, which may comprise information as to the location, availability and health of the charging module so that the electric work vehicle may avoid travelling to a charging module that is occupied, has insufficient power or charge, or is experiencing issues.

### BRIEF DESCRIPTION OF THE DRAWINGS

A specific embodiment of the disclosure will now be described, by way of example only, with reference to the accompanying drawings in which:

FIG. 1 shows a schematic diagram of an electric work vehicle communicating with a charging module according to an embodiment of the present disclosure.

FIG. 2 shows a schematic diagram of an electric work vehicle communicating with a charging module via a central controller according to an embodiment of the present disclosure.

### DETAILED DESCRIPTION

Electric work vehicles commonly operate off road at work sites, for example on construction sites or at mining sites. The plurality of electric work vehicles at the work site will need to be charged. In order to efficiently charge the electric work vehicles, the electric work vehicle and charging module need to communicate. For example, communicating a status of a charging module to an electric work vehicle prevents the electric work vehicle wasting time and charge travelling to a charging module that is in use by another electric work vehicle, that is low on power or charge, or that is otherwise unusable. Communicating the location of the charging modules, which may differ between work sites or even over time in the same work site, means that the electric work vehicles can travel efficiently to the charging module. Similarly, communicating properties of the electric work vehicles to the charging modules allows efficient charging of the electric work vehicles, for example by ensuring that the electric work vehicle travels to a charging module that can provide at least the amount of charge required by the electric work vehicle.

Recharging an electric work vehicle can be time consuming, and queues may form at charging modules. Communication between the charging module and the electric work vehicle allows the electric work vehicle to travel to a charging module that is or that soon will be available.

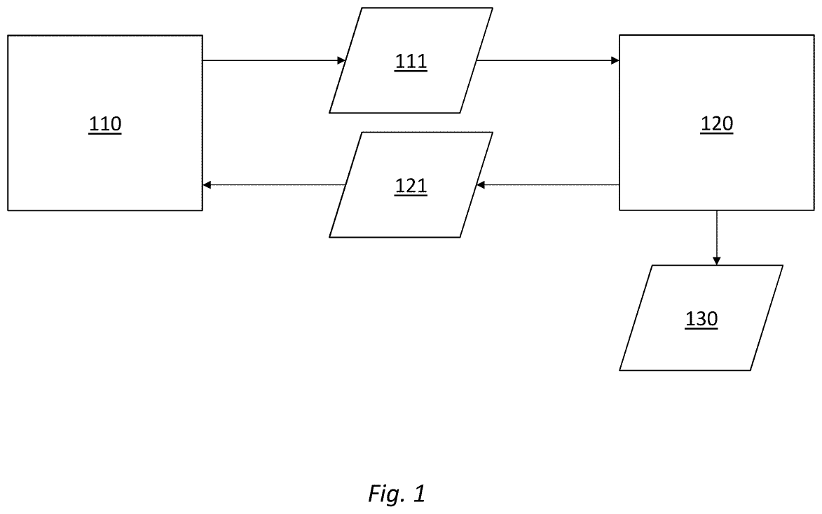

With reference to FIG. 1, a method of charging management for electric work vehicles comprises communicating charger properties 111 from a charging module 110 to an electric work vehicle 120 and communicating vehicle properties 121 from the electric work vehicle 120 to the charging module 110. Charging information 130 is provided to an operator. The charging information 130 is based on the charger properties 111 and the vehicle properties 121. The charger properties 111 comprise a location of the charging module 110 and an availability of the charging module 110. The vehicle properties comprise a current state of charge of a battery of the electric work vehicle and a capacity of the battery of the electric work vehicle.

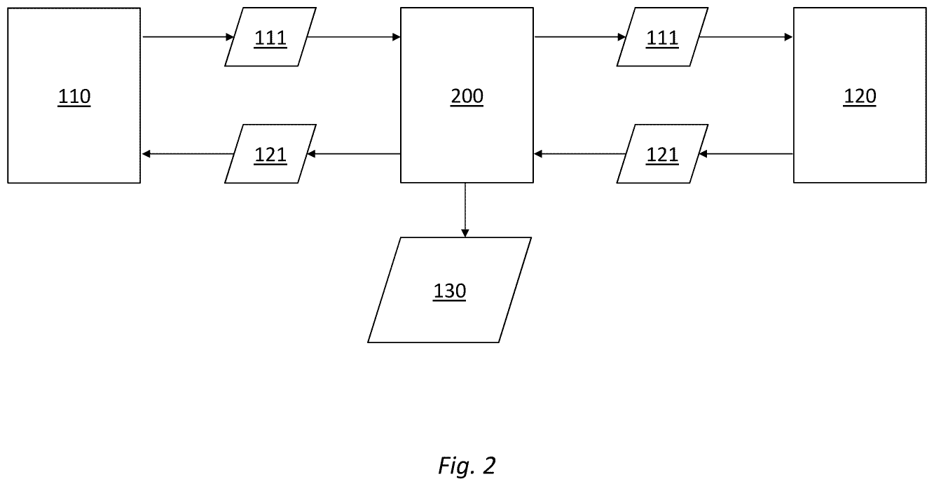

Communicating charger properties 111 to the electric work vehicle 120 and communicating vehicle properties 121 to the charging module 110 may occur at the same time, or sequentially in either order. The charger properties 111 and vehicle properties 121 may be communicated continuously or at regular intervals. The charger properties 111 and vehicle properties 121 may alternatively be communicated on demand, for example in response to a request by an operator. The charger properties 111 and vehicle properties 121 may be communicated directly between the charging module 110 and the electric work vehicle 120. With reference to FIG. 2, the charger properties 111 and vehicle properties 121 may be communicated between the charging module 110 and the electric work vehicle 120 via a central controller 200. The central controller may provide the charging information 130.

The charging module 110 and the electric work vehicle 120 may each comprise a telematics module. The telematics modules may be configured to send and receive the charger properties 111 and the vehicle properties 121.

The electric work vehicle 120 may communicate vehicle properties 121 to and receive charger properties 11 from more than one charging module 110. The charging module 110 may communicate charger properties 111 to and receive vehicle properties 121 from more than one electric work vehicle 120.

The charging module may comprise a mains supply, or may not be connected to the mains supply. The charging module may comprise a power pack. The charger may comprise a generator.

The charger properties 111 may further include a health status of the charger. For example, whether the charger is working, and whether there is any damage to the charger or limited capability of the charger. The charger properties 111 may further comprise a charging capacity of the charger. For example, in the event that the charger is not connected to the mains supply, it may have a limited amount of charge available. The charging capacity may comprise a state of charge of power pack. In an embodiment, the charging capacity may comprise either an indication that the charger has sufficient charge to fully charge the battery, or an indication of the predicted state of charge of the battery after fully draining the charger. The charger properties 111 may further comprise a charging rate of the charger, and a charger connection type (such as DC, AC, three phase).

The charger properties 111 comprise an availability of the charging module 110. The availability of the charging module 110 may comprise an indication of whether the charger is in use and a reservation status of the charger. For example, the charger may be currently in use, currently free, reserved for use at a certain time by another vehicle, or unreserved. In an event that the charger is in use, the availability of the charging module 110 may further comprise a predicted charging end time at which the charger will be available. Similarly, in an event that the charger is reserved, the availability of the charging module 110 may further comprise a period when the charger is free prior to the reservation and/or a predicted end time of the reservation.

The predicted charging end time may be communicated from the charger to the electric work vehicle 120. The predicted charging end time may be calculated by the electric work vehicle 120 or central controller based on a current state of charge of the battery being charged, a target state of charge of the battery being charged, and a charging rate of the charger. In an event that the charger is not connected to the mains supply, the charger properties 111 may further comprise a predicted state of charge of the charger at the predicted charging end time.

In an embodiment, the charger may comprise a DC charger and the charger properties may further comprise a DC voltage of the charger.

The vehicle properties 121 may further comprise a predicted time before charging is required. The predicted time may be based on at least one of a current state of charge, a discharge rate, and a distance from the charger. The discharge rate may be based on a current discharge rate. The discharge rate may be based on data from previous discharging of the battery, for example data comprising discharge rates at different states of charge, or discharge rates for the operator, or discharge rates for performing various tasks with the vehicle. The distance from the charger may be used to calculate the state of charge required to travel to the charger, and therefore the minimum state of charge that the vehicle can reach before needing to travel to the charger.

The vehicle properties 121 may further comprise an available time period for charging. The available time may be based on a return-to-work time for the electric work vehicle 120. For example, the electric work vehicle 120 may be charged at the end of an operator's shift, and the return-to-work time may comprise the beginning of the next shift for the electric work vehicle 120 (for the same or a different operator). Otherwise, an available time period may comprise a lunch break of the operator, a weekend, a closed period of the worksite, or other time period.

The vehicle properties 121 may further comprise a target state of charge for charging the battery. For example, the target state of charge may be to fully charge the battery to a 100% state of charge. The target state of charge may comprise a state of charge that has been determined to be appropriate to maintain good battery health. The target state of charge may be the state of charge required to complete the next task or the next shift.

The vehicle properties 121 may further comprise at least one of a battery voltage, a maximum charge rate of the battery, a state of health of the battery, and a temperature of the battery.

The charging module 110 may comprise a geofence. The geofence may define a perimeter around the charging module 110, for example based on a radius from the charging module 110. Within the geofence, a speed of the electric work vehicle 120 may be limited to below a threshold speed, and/or the electric work vehicle 120 may be limited in the tasks it can perform. There may be other limitations, such as the number of electric work vehicles permitted to be within the geofence at any one time. The charger properties may further comprise the geofence and any limitations on the electric work vehicle 120 that occur within the geofence.

In an embodiment, the charging information 130 provided to the operator may comprise information to allow the operator to make an informed charging decision. For example, the charging information 130 may comprise the predicted time before charging is required and distances to available charging modules. In another embodiment, the charging information 130 provided to the operator may comprise a result of a charging decision made by a controller (either the central controller or a controller of the electric work vehicle). For example, the controller may decide which charging module 110 the electric work vehicle 120 should travel to, and when the electric work vehicle 120 should travel to or arrive at the charging module.

The method may further comprise making a reservation of the charging module 110. The reservation may be made by the operator based on the charging information 130. The reservation may be suggested to the operator by a controller based on a charging decision made by the controller, and the operator may confirm or reject the reservation. The reservation may be made by a controller based on a charging decision made by the controller, without input from the operator.

The method of charging management may comprise communicating charger properties 111 from a plurality of charging modules 110 to an electric work vehicle 120. The charging information 130 may be based on the charger properties 111 for the plurality of charging modules 110, such that the charging decision (made by the operator or a controller) comprises a decision of whether or when to charge the electric work vehicle, and which charging module to use.

The charging information 130 may be provided to the operator via a display in the electric work vehicle cab, via a smartphone, or by other means.

According to an embodiment, there is a charging management device for electric work vehicles. The charging management device is configured to communicate charger properties 111 from a charging module 110 to an electric work vehicle and communicate vehicle properties 121 from the electric work vehicle 120 to the charging module 110. The charging management device is further configured to provide charging information 130 to an operator, wherein the charging information 130 is based on the charger properties 111 and the vehicle properties 121. The charger properties 111 comprise location of the charging module 110 and an availability of the charging module 110. The vehicle properties 121 comprise a current state of charge of a battery of the electric work vehicle 120 and a capacity of the battery of the electric work vehicle 110.

The charging management device may be configured to carry out any of the methods described above. The charging management device may comprise a controller (either a central controller or a controller on the electric work vehicle 120). The charging management device may comprise a telematics device on the charging module 110, and a telematics device on the electric work vehicle 120.

1. A method of charge management for electric work vehicles, the method comprising:
communicating charger properties from a charging module to an electric work vehicle;
communicating vehicle properties from the electric work vehicle (120) to the charging module; and
providing charging information to an operator, wherein the charging information is based on the charger properties and the vehicle properties;
wherein the charger properties comprise:
a location of the charging module; and
an availability of the charging module; and
wherein the vehicle properties comprise:
a current state of charge of a battery of the electric work vehicle;
a capacity of the battery of the electric work vehicle;
an available time period for charging based on a return-to-work time of the electric work vehicle; and
a predicted time before charging is required, wherein the predicted time is based on data from previous discharging of the battery of the electric work vehicle comprising one or more of:
discharge rates at different states of charge;
discharge rates for the operator; and
discharge rates for performing various tasks with the electric work vehicle.

2. The method of claim 1 wherein the charger properties further comprise one or more of:
a health status of the charging module;
a charging capacity of the charging module;
a charging rate; and
a charging module connection type.

3. The method of claim 1 wherein the availability of the charging module comprises at least one of:
an indication of whether the charging module is in use; and
a reservation status of the charging module.

4. The method of claim 3 wherein in the event that the charging module is in use, the availability of the charging module comprises a predicted charging end time.

5. The method of claim 4 wherein the predicted charging end time is either:
communicated from the charging module to the electric work vehicle; or
calculated by the electric work vehicle based on a current state of charge of the battery being charged, a target state of charge of the battery being charged, and a charging rate of the charging module.

6. The method of claim 1 wherein charging module comprises a DC charger and wherein the charger properties further comprise a DC voltage.

7. The method of claim 1, wherein the vehicle properties further comprise at least one of:
a predicted time before charging is required;
an available time period for charging; and
a target state of charge for charging.

8. The method of claim 1, wherein the vehicle properties further comprise at least one of:
a battery voltage;
a maximum charge rate of the battery;
a state of health of the battery; and
a temperature of the battery.

9. The method of claim 1 wherein communicating charger properties and communicating vehicle properties is via a separate controller.

10. The method of claim 1 wherein the charging module and the electric work vehicle each comprise a telematics module.

11. The method of claim 1 wherein the charger properties further comprise a radius around the charging module in which a speed of the electric work vehicle is limited to below a threshold speed.

12. The method of claim 1 wherein the charging information comprises a result of a charging decision made by a controller.

13. The method of claim 1 further comprising making a reservation of the charging module.

14. A charge management device for electric work vehicles, the charge management device configured to:
communicate charger properties from a charging module to an electric work vehicle:
communicate vehicle properties from the electric work vehicle to the charging module: and
provide charging information to an operator, wherein the charging information is based on the charger properties and the vehicle properties;
wherein the charger properties comprise:
a location of the charging module; and
an availability of the charging module; and
wherein the vehicle properties comprise:
a current state of charge of a battery of the electric work vehicle:
a capacity of the battery of the electric work vehicle:
an available time period for charging based on a return-to-work time of the electric work vehicle: and
a predicted time before charging is required, wherein the predicted time is based on data from previous discharging of the battery of the electric work vehicle comprising one or more of:
discharge rates at different states of charge;
discharge rates for the operator; and
discharge rates for performing various tasks with the electric work vehicle.

15. The charge management device of claim 14 wherein the charger properties further comprise one or more of:
a health status of the charging module
a charging capacity of the charging module;
10 a charging rate; and
a charging module connection type.
